(19) United States
(12) Patent Application Publication
(10) Pub. No.: US 2014/0260999 A1
(43) Pub. Date: Sep. 18, 2014

(54) BEVERAGE VENDING SYSTEM

(71) Applicant: Advanced Services, Bensalem, PA (US)

(72) Inventors: Eric CARDONICK, Holland, PA (US); Ron FORDE, Philadelphia, PA (US)

(73) Assignee: Advanced Services, Bensalem, PA (US)

(21) Appl. No.: 14/215,691

(22) Filed: Mar. 17, 2014

Related U.S. Application Data
(60) Provisional application No. 61/827,904, filed on May 28, 2013.
(60) Provisional application No. 61/787,139, filed on Mar. 15, 2013.

(51) Int. Cl. A47J 31/40; A47F 1/04

(52) U.S. Cl. CPC A47J 31/407; A47F 1/04
USPC 99/290; 221/92

(57) ABSTRACT

A beverage vending system includes a vending machine with a housing having a plurality of racks therein, each rack storing vending items. One of the vending items is a kit cup. Each kit cup includes a cup, a lid and a beverage pod. The racks are directly inaccessible by a user of the vending machine, and the housing includes an access area, accessible to a user for retrieving a dispensed kit cup. A control panel includes a user interface for selecting a vending item and a currency exchange system for receiving currency from a user. A dispensing mechanism is operatively connected between the control panel and the plurality of racks. In response to the user selecting a vending item and paying of the associated purchase value, the dispensing mechanism actuates a rack storing the selected vending item, to, in turn, dispense one such selected item to the access area.

### CROSS-REFERENCE TO RELATED APPLICATIONS

The present application claims the benefit of U.S. Provisional Application No. 61/787,139, filed Mar. 15, 2013, entitled “System and Method for Coffee Vending,” and similarly-titled U.S. Provisional Application No. 61/827,904, filed May 28, 2013, the subject matter of each of which is expressly incorporated by reference in its entirety herein.

### BACKGROUND OF THE INVENTION

The present invention relates generally to vending of hot beverages, such as coffee. More specifically, the present invention relates to a beverage vending system for vending hot beverages through the use of a vending machine.

Many public and private venues, including stores, repair shops, workplaces, and the like, offer complimentary coffee and other hot beverages as a courtesy or as a benefit to visitors, patrons, employees, and the like. Traditionally, community coffee pots and/or thermoses full of coffee were kept at the venue, and periodically refreshed by venue staff. Recently, coffee distribution has shifted from the use of community coffee pots and thermoses to the use of individual, single-serve coffee containers, i.e., coffee pods, such as the “K-Cup” offered by KEURIG and others.

The use of coffee pods has several advantages over community coffee pots that make them desirable to consumers. First, since coffee pods provide a single serving of coffee, each individual consumer may brew an individual fresh cup of coffee every time a cup of coffee is desired. Second, the single serving size allows a wide range of different coffees and hot beverages to be offered to consumers, a benefit offered at many work places. However, one drawback associated with coffee pods is that individual coffee pods are typically more expensive to purchase than purchasing coffee in bulk, and the entire cost is typically absorbed by the offering organization, resulting in an increase in overhead for the organization. Furthermore, because of their portability and expense, coffee pods are an attractive item to be taken without permission.

Accordingly, it is desirable to provide a system of controlling the distribution of coffee pods to users in public and private venues. It is further desirable to offset the cost of coffee pods by providing a system for vending the coffee pods, alone, or as part of a coffee kit, to users for a cost.

### BRIEF SUMMARY OF THE INVENTION

An aspect of the invention is directed to a beverage vending system for vending a beverage item to a purchaser. The beverage vending system comprises a vending machine, which comprises a housing having a plurality of racks therein, each rack storing respective purchasable vending items. One of the purchasable vending items is a kit cup, and each kit cup includes a cup, a lid and a beverage pod stored therein. The racks are directly inaccessible by a user of the vending machine, and the housing includes an access area which is accessible to a user for retrieving a dispensed, selected kit cup. The vending machine further comprises a control panel including a user interface having a user input which selects a vending item to be purchased and a currency exchange system that can receive currency from a user for purchasing a selected kit cup, and a dispensing mechanism operatively connected between the control panel and the plurality of racks. In response to the user selecting a vending item using the user interface and paying the associated purchase value to the currency exchange system, the dispensing mechanism is configured to actuate a rack storing the selected vending item, to, in turn, dispense one such selected item to the access area.

In accordance with another aspect, the invention is directed to a beverage vending system for vending a beverage item to a purchaser. The beverage vending system comprises a vending machine, which comprises a housing having a plurality of racks therein, each rack storing respective purchasable vending items. One of the purchasable vending items is a kit cup. Each kit cup includes a cup, a lid and a beverage pod stored therein. The racks are directly inaccessible by a user of the vending machine, and the housing includes an access area which is accessible to a user for retrieving a dispensed, selected kit cup. The vending machine further comprises a control panel including a user interface having a user input which selects a vending item to be purchased and a currency exchange system that can receive currency from a user for purchasing a selected kit cup. In response to the user selecting a vending item using the user interface, and paying the associated purchase value to the currency exchange system, a rack storing the selected vending item is actuated via a dispensing mechanism operatively connected between the control panel and the plurality of racks, to, in turn, dispense one such selected item to the access area.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings an embodiment which is presently preferred. It should be understood, however, that the invention is not limited to the precise arrangements and instrumentalities shown. In the drawings:

FIG. 1 is front perspective view of a vending system in accordance with the present invention, including a vending machine having a plurality of kit cups and a brewing station;

FIG. 2 is a schematic block diagram of the operative components of the vending machine of FIG. 1;

FIG. 3A is a schematic front elevational view of an exemplary brewing station with a pod brewer and a trash receptacle;

FIG. 3B is a schematic top plan view of the brewing station of FIG. 3A with a cutout for access to the trash receptacle;

FIG. 4 is an exemplary schematical layout of the vending items of vending machine of FIG. 1, having a plurality of kit cups;

FIG. 5 is another exemplary schematical layout of the vending items of the vending machine of FIG. 1, with a compartment for housing an independent water source underneath; and

FIG. 6 is an enlarged exploded view of an exemplary kit cup.

### DESCRIPTION OF THE DISCLOSURE

Certain terminology is used in the following description for convenience only and is not limiting. The words “right,” “left,” “top,” “bottom,” “upper” and “lower” designate directions in the drawings to which reference is made. The words “first,” “second,” “third” and “fourth” designate an order of operations in the drawings to which reference is made, but do not limit these steps to the exact order described. The words “inwardly” and “outwardly” refer to directions toward and away from, respectively, the geometric center of a device and designated parts thereof. Unless specifically set forth herein, the terms “a,” “an” and “the” are not limited to one element, but instead should be read as meaning “at least one.” The terminology includes the words noted above, derivatives thereof and words of similar import. It should also be understood that the terms “about,” “approximately,” “generally,” “substantially” and like terms, used herein when referring to a dimension or characteristic of a component of the invention, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

Preferred embodiments of the present invention relate to a beverage vending system for hot beverages such as tea, chai, hot chocolate, soup, coffee, and the like. More particularly, preferred embodiments of the present invention relate to a coffee or other hot beverage vending system including a vending machine for dispensing kit cups for use in a brewing station. It should be understood that the present beverage vending system is not limited to coffee.

Referring to the drawings in detail, wherein like numerals and characters indicate like elements throughout, there is shown in FIGS. 1-6, a vending system 100 in accordance with the present invention. As shown in FIG. 1, the vending system 100 includes a vending machine 110 configured to vend a plurality of kit cups 140 upon input of value, i.e., currency, by a user. The vending system 100 may also include a beverage brewing station 120, operatively associated with the vending machine 110 (as will be described further below), having a pod brewer 130 and a trash receptacle 210.

The vending machine 110 may take the form of any of numerous different conventional vending machines currently known. Thus, as should be understood by those of ordinary skill in the art, and as shown in FIG. 1, the vending machine 110 comprises a housing 111 having a plurality of racks 113 therein, each rack storing respective purchasable vending items. In the illustrated embodiment of FIG. 1, the racks 113 are standard spiral shaped racks movable in a rotary screwing motion, wherein each vending item is stacked within a respective coil of the spiral rack 113. One full revolution of the coil-shaped rack 113 disengages the front most vending item in the rack 113, such that it may be dispensed. However, as should be understood by those of ordinary skill in the art, any of numerous different conventional racks utilized in conventional vending machines may alternatively be utilized.

As shown in FIG. 1, the housing 111 may include a transparent front wall, e.g., clear glass or plastic front wall, such that a consumer may directly view the purchasable vending items within the racks 113. Alternatively, the housing 111 may not include any transparent sides, but rather may have drawings or pictures thereon, identifying the different purchasable items. The housing 111 is generally closed around the racks 113 for normal use, and thus the racks 113 are directly inaccessible by a user of the vending machine 110. That is, a consumer may not directly access the racks 113 and directly retrieve a vending item therefrom. Conversely, the owner of the vending machine, or a company hired to maintain the vending machine, may be able to unlock and open the housing 11 to directly access the vending items, e.g., to restock the racks 113, in a manner well understood by those of ordinary skill in the art. Accordingly, detailed description thereof is omitted for convenience and brevity only. The housing 111 includes a designated access area 115, which is accessible to a user to retrieve a selected and dispensed vending item. For example, as shown in FIG. 1, the designated access area 115 is located below the racks 113, such that a dispensed vending item may fall out of the racks 113 and into a compartment defining the access area 115. In the illustrated embodiment, the access area 115 includes a pivotable front door 117 that a user may push in with his/her hand to reach into the access area 115 and retrieve the dispensed vending item. However, as should be understood by those of ordinary skill in the art, the access area may alternatively not include a front door but rather have an open front end, such that a user may reach into the access area compartment without pushing through a door.

As should also be understood by those of ordinary skill in the art, the vending machine 110 further includes a conventional control panel 116 having a user interface 112 for user input, e.g., a keypad, touchpad, or the like, to select a vending item to be purchased and a currency exchange system 114 that can receive currency, including, but not limited to, credit cards, debit cards, coins, bills, tokens, chits, employee access cards, stored value cards, and the like, from a user for purchasing a selected vending item. The user interface 112 may include several keys, e.g., touch or manual buttons, identified by numbers, letters or symbols. Each rack 113 is associated with a specific key combination. As should be understood, in response to a user selecting a vending item by entering the associated key combination into the user interface 112 and paying the associated purchase value to the currency exchange system 114, a dispensing mechanism 118, operatively connected between the control panel 116 and the racks 113 (FIG. 2), actuates a rack 113 storing the selected vending item, to, in turn, dispense one such selected item to the access area 115. As should be understood, the dispensing mechanism 118 comprises a motor and transmission system (not shown) drivingly attached to the different racks 113, which turns the coils of the racks 113. Accordingly, once the control panel 116 determines that a selection and the correct amount of money have been entered, the control panel 116 triggers operation of the dispensing mechanism 118 to turn the appropriate rack 113 in order to dispense the selected item in a manner well understood by those of ordinary skill in the art.

A plurality of selectable vending options are arranged in the racks 113 of the vending machine 110 for purchase by a consumer. In the preferred embodiment, at least a subset of the selectable vending options offered by the vending machine 110 are kit cups 140. Other items, such as traditional snacks 141 offered by prior art vending machines may also be included for sale by the vending machine 110. As shown in FIG. 6, each kit cup 140 includes a cup 142, a lid 144, and a beverage pod 148, such as, for example, without limitation, a “K-cup.” In some embodiments, each kit cup 140 also includes a condiment packet 146, including, for example, sugar, creamer, and/or a stirrer. However, the condiment packet 146 may also be vended separately, as shown in FIG. 4. The cup 142 may be any size, but is preferably a twelve (12) ounce insulated cup suitable for maintaining hot liquids. Various shapes, sizes, and configurations of beverage pod packets 148 are known to those skilled in the art, including both soft and hard pack type pods. Such pod packets 148 are offered by a plurality of manufacturers, and any such pod packet 148 may be used as long as it is compatible with the selected pod brewer 130.

Though it is contemplated that a variety of distinct kit cups 140 having various types of beverage pods 148 (caffeinated, decaffeinated, flavored, unflavored, teas, hot chocolate, chai, coffees, and the like) will be offered by each vending machine 110, in some embodiments, each kit cup 140 offered by a vending machine 110 will be identical to each other. A sample layout of a vending machine 110 is shown in FIG. 4. Preferably, labels 150 are arranged under each kit cup 140 as shown in FIG. 4 to identify the contents, and/or type/flavor of beverage, within a kit cup 140 and display a selection identifier associated with each kit cup 140. Alternatively, or additionally, each kit cup 140 may be so labeled. Additional condiment packets 146, creamers 154, and other accessories may be available for purchase through the vending machine 110, or may be included within a kit cup 140.

As shown in FIGS. 1, 3A and 3B, as stated above, the beverage brewing station 120 is operatively associated with the vending machine 110. This means the brewing station 120 or pod brewer 130 alone is within a reasonably close proximity to the vending machine 110 so that it is conveniently used. For instance, the beverage brewing station 120 may be positioned directly adjacent the vending machine 110 and configured in size and shape and dressed similarly to the vending machine 110 so that the brewing station 120 and the vending machine 110 may be paired together at the venue. Alternatively, the brewing station 120 may be built into a compartment of the vending machine 110. Yet alternatively, the brewing station 120 and/or pod brewer 130 may stand alone nearby the vending machine 110, e.g., within the same room, such as, for example, within a kitchenette at the venue or in an immediately adjacent room. Thus, other sizes and shapes of the beverage brewing station 120 may be used without departing from the scope of this invention. For example, the brewing station 120 may be of different design and/or color from the vending machine. As another example, the brewing station 120 may be built into existing counters, and therefore have the design of the existing counters. In the illustrated embodiment, the beverage brewing station 120 includes a generally parallelepiped shaped compartment 122 that is easily accessible by a consumer. The compartment 122 is configured to fixedly maintain the pod brewer 130 on a planar surface 122a within the compartment 122 such that the user is able to easily operate the pod brewer 130. As should be understood by those of ordinary skill in the art, the pod brewer 130 is generally coupled to a water supply and an electrical power supply provided by the venue.

In some embodiments, as shown in FIG. 3A, the beverage brewing station 120 includes a hidden compartment 124 underneath the pod brewer 130, housing a trash bin 210. Referring to FIG. 3B, the planar surface 122a of the compartment 122 includes a generally rectangular cutout 126 providing access to the hidden compartment 124 below. Preferably, the pod brewer 130 is secured to the planar surface 122a such that used beverage pods 148 are automatically discarded from the pod brewer 130 directly into the underlying trash bin 210 through the cutout 126.

In some embodiments, the vending machine 110 may further include a water reservoir 310 and a water pump 320, as shown in FIG. 5, to accommodate venues not having a water supply nearby the area in which the vending system 100 is located. Preferably, the water reservoir 310 and the water pump 320 are hidden in a compartment 305 of the vending machine 110 such that it is not visible or accessible to unauthorized users to prevent such users from tampering with the water in the water reservoir 310. The water pump 320 of the vending machine 110 is coupled to the beverage brewing station 120. Preferably, the water reservoir 310 is sized to last an entire day's use (e.g., five gallons or more), without requiring replacement or refilling.

In operation, a user inputs value into the vending machine 110 using the currency exchange system 114, and selects a kit cup 140 using the user interface 112, as described above. In response to the user inserting the required amount of value and making the selection, the dispensing mechanism 118 actuates the appropriate rack 113 to dispense the selected kit cup 140 into the access area 115. Upon collecting the vended kit cup 140 from the access area 115, the user unpacks the kit cup 140 and inserts the beverage pod 148 and the cup 142 into the pod brewer 130. Once inserted, the user initiates the brewing process of the pod brewer 130 to dispense a cup of coffee or other hot beverage. After completing the brewing process, the user retrieves the cup 142 having the brewed beverage, while the pod brewer 130 automatically disposes of the used beverage pod 148 into the trash receptacle 210. The user may then add sugar and/or creamer from the condiment packet 146 to the brewed beverage and stir, and then cover the cup 142 with the lid 144 if desired.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A beverage vending system for vending a beverage item to a purchaser, comprising:
a vending machine comprising:
a housing having a plurality of racks therein, each rack storing respective purchasable vending items, wherein one of the purchasable vending items is a kit cup, each kit cup including a cup, a lid and a beverage pod stored therein, the racks being directly inaccessible by a user of the vending machine, and the housing including an access area which is accessible to a user for retrieving a dispensed, selected kit cup;
a control panel including a user interface having a user input which selects a vending item to be purchased and a currency exchange system that can receive currency from a user for purchasing a selected kit cup; and
a dispensing mechanism operatively connected between the control panel and the plurality of racks, and configured to actuate a rack storing the selected vending item, to, in turn, dispense one such selected item to the access area, in response to the user selecting a vending item using the user interface and payment of the associated purchase value to the currency exchange system.

2. The beverage vending system of claim 1, wherein the kit cup further includes a condiment packet.

3. The beverage vending system of claim 1, the kit cup further comprising a label identifying the type of beverage in the respective beverage pod within a respective kit cup.

4. The beverage vending system of claim 1, wherein the cup is a 12 oz. insulated cup.

5. The beverage vending system of claim 1, wherein the beverage pod is a K-Cup.

6. The beverage vending system of claim 1, the beverage pod is a coffee pod.

7. The beverage vending system of claim 1, wherein other purchasable vending items stored in the vending machine include a variety of snacks.

8. The beverage vending system of claim 1, further comprising a brewing station operatively associated with the vending machine and having a brewer configured to accept the beverage pod.

9. The beverage vending system of claim 8, wherein the brewing station comprises a first compartment storing a trash receptacle, a second compartment storing the brewer, at least one surface separating the first compartment and the second compartment, and a cutout in the at least one surface allowing used beverage pods to be discarded from the brewer into the trash receptacle.

10. The beverage vending system of claim 9, wherein the first compartment is a hidden compartment, and the second compartment is accessible to users of the vending system.

11. The beverage vending system of claim 8, wherein the vending system further includes a water reservoir and a water pump configured to supply water from the water reservoir to the brewer.

12. The beverage vending system of claim 8, wherein the brewing station is positioned adjacent the vending machine.

13. A beverage vending system for vending a beverage item to a purchaser, comprising:
a vending machine comprising:
a housing having a plurality of racks therein, each rack storing respective purchasable vending items, wherein one of the purchasable vending items is a kit cup, each kit cup including a cup, a lid and a beverage pod stored therein, the racks being directly inaccessible by a user of the vending machine, and the housing including an access area which is accessible to a user for retrieving a dispensed, selected kit cup;
a control panel including a user interface having a user input which selects a vending item to be purchased and a currency exchange system that can receive currency from a user for purchasing a selected kit cup;
wherein, in response to the user selecting a vending item using the user interface and paying the associated purchase value to the currency exchange system, a rack storing the selected vending item is actuated via a dispensing mechanism operatively connected between the control panel and the plurality of racks, to, in turn, dispense one such selected item to the access area.

14. The beverage vending system of claim 13, further comprising a brewing station operatively associated with the vending machine and having a brewer configured to accept the beverage pod.
